(19) United States
(12) Patent Application Publication
(10) Pub. No.: US 2006/0072974 A1
(43) Pub. Date: Apr. 6, 2006

(54) Miter dowel jig

(76) Inventor: Eric Johnson, Houston, TX (US)

Correspondence Address: Eric Johnson, PO Box 981041, Houston, TX, 77098, US

(21) Appl. No.: 10/969,295

(22) Filed: Oct. 5, 2004

(51) Int. Cl. B23B 49/02

(52) U.S. Cl. 408/115 R

(57) ABSTRACT

A miter dowel jig comprised of two plates that when assembled form a complete unit. This unit may be used as a jig fixture to drill holes in various materials for the preparation of the placement of dowels in a mitered joint of various angles.

### BACKGROUND OF THE INVENTION:

1) Field of Invention

The present invention relates to a jig in making and assembly of a doweled miter joint such as corner joints in picture frame moldings, window moldings, architectural moldings, mirror frames and the like.

2) Description of Prior Art

As far as known, there appears to be no prior art patent dealing with an assembly that is used as a miter jig to aid in the fabrication and placement of dowels in a mitered joint.

### SUMMARY OF INVENTION

The present invention provides a new and improved fixture for the method of preparing a mitered joint to be constructed with dowels. This particular jig's innovation is do to the fact that it is composed of precisely drilled holes that allow the exact drilling and placement of perfectly aligned holes in materials that are used in the making of a mitered joint. The jig allows for the perfect alignment of dowel holes in two pieces of material that will be used to construct a mitered joint. The jig provides a precise and quick method to fabricate a doweled joint with precise repeatability. The jig may be used in an unlimited range of angles for mitered joints thereby increasing the flexibility of creating a doweled joint.

### BRIEF DESCRIPTION OF THE DRAWING

FIG. 1A is a two dimensional top view of the Miter Dowel Jig,

FIG. 1B is a two dimensional side view of the Miter Dowel Jig

FIG. 2 is an application of the Miter Dowel Jig

FIG. 3 is an application of the Miter Dowel Jig with doweled material

FIG. 4 is an application of the Miter Dowel Jig with a doweled miter joint

### DESCRIPTION OF THE EMBODIMENT

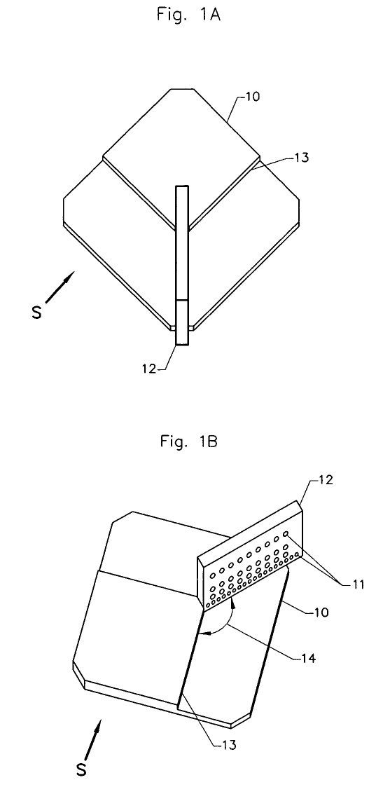

In the drawings (FIG. 1A) and (FIG. 1B) the letter S designates generally a new and improved miter dowel jig according to the present invention. The dowel jig S (FIG. 1A) consists of a support plate 10 made of various materials and plate 12 made of various materials. Support plate 10 consists of a flat plate with a stop 13 to provide support and exact location of materials to be doweled and mitered. Boring plate 12 (FIG. 1B) consists of a number of holes 11 that are of various diameter sizes. Plate 12 is attached to plate 10 as in (FIG. 1A) such that an angle 14 (FIG. 1B) is formed with stop 13 and plate 12. The angle 14 is the angle of the designated miter joint.

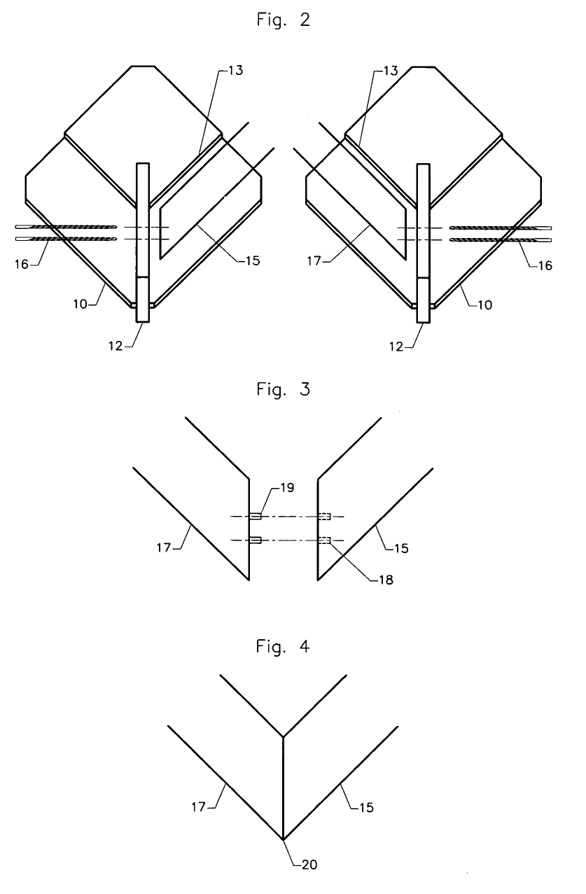

The miter dowel process is effected with the invention S (FIG. 2) by placing a piece of designated material 15 against the stop 13 and against plate 12. A drill 16 (FIG. 2) is then used to drill or bore a hole of the selected diameter through the hole 11 (FIG. 1B) in plate 12 into the material 15. A second piece of designated material 17 (FIG. 2) is placed on the opposite side of plate 12 (FIG. 2) and a drill 16 is used to drill or bore a hole of the selected diameter through the hole 11 in plate 12 into the material 17. The two pieces of material 15 and 17 now have aligned holes 18 (FIG. 3) in each end. A dowel 19 (FIG. 3) is placed in the hole 18 of 17 and then 17 is joined to 15 by the dowel 19 and hole 18 in 15, creating a doweled mitered joint 20 (FIG. 4).

The principles, preferred embodiment, and mode of operation of the present invention have been described in the forgoing specification. The invention is not to be construed as limited to the particular forms disclosed since these are regarded as illustrative rather than restrictive. Moreover, variations and changes may be made by those skilled in the art without departing from the spirit of the invention.

1-3. (canceled)

4. A miter dowel jig comprising; a support plate; a stop perpendicularly oriented in the support plate; a boring plate; a plurality of horizontal holes oriented therethrough in the boring plate; and an angle oriented within the support plate and the boring plate

5. A miter dowel jig of claim 4 further comprising of the non pivot attachment of the boring plate to the support plate.

6. A miter dowel jig of claim 4 further comprising of two stops each separately oriented on the opposite side of the boring plate.

7. A miter dowel jig of claim 4 further comprising of a fixed, non adjustable angle between the stop and the boring plate, said angle is 135 degrees.

8. A miter dowel jig of claim 4 further comprising of two non adjustable 135 degree angles, said angles are mirror images, and said angles, are separately oriented on the opposite side of the boring plate and along the stop on the support plate.

9. A miter dowel jig of claim 4 further comprising of a boring plate with plurality of horizontal holes, said holes oriented there through on opposite sides of the boring plate.

10. A miter dowel jig of claim 4 further comprising of a plurality of horizontal holes in the boring plate, said holes are there through oriented on opposite sides of the boring plate as a mirror image of said holes in each side of the boring plate.

11. A miter dowel jig of claim 4 further comprising of a boring plate with a plurality of horizontal holes said holes are there through oriented to guide a drill bit through the boring plate.
